(19) United States
(12) Patent Application Publication
(10) Pub. No.: US 2004/0129024 A1
(43) Pub. Date: Jul. 8, 2004

(54) Method for reducing the adhesion tendency during the hot forming of glass

(76) Inventors: Ulrike Stoehr, Mainz (DE); Olaf Claussen, Ingelheim (DE); Daniela Seiler, Moerfelden (DE); Sylvia Biedenbender, Bingew (DE); Gernot Roeth, Dalheim (DE); Ralf-Dieter Werner, Laufersweiler (DE)

Correspondence Address: Striker Striker & Stenby, 103 East Neck Road, Huntington, NY, 11743, US

(21) Appl. No.: 10/474,116

(22) PCT Filed: Apr. 10, 2002
(86) PCT No.: PCT/EP02/03987

(30) Foreign Application Priority Data
Apr. 10, 2001 (DE) 10117818.2

(51) Int. Cl. C03B 40/00

(52) U.S. Cl. 65/24; 65/102; 65/374.11; 65/374.12; 65/374.13; 65/169; 65/170

(57) ABSTRACT

The invention relates to a method and a device for reducing the adhesion tendency during the hot forming of a glass body, using at least two moulds, which are positioned on either side of the glass body and are brought into contact with the glass body at a temperature, at which the glass is deformable, whereby the moulds are configured with electrically conductive surfaces. The disadvantage of existing methods and devices is that the moulds have a tendency to adhere to the glass body to be formed and that the surface quality of the glass is impaired. The invention therefore discloses a method, according to which the conductive surfaces of the moulds that come into contact with the glass body are supplied with an alternating current. The device for carrying out said method has electrically conductive mould surfaces, which are connected to an alternating current source. This guarantees that a larger processing window is available as a result of the reduced adhesion tendency, i.e. a greater flexibility in, for example, the temperature, the forming pressure and the duration of contact, achieving an improved glass quality.

The present invention relates to a method for reducing the adhesion tendency during the hot forming of a glass body, using at least two moulds, which are positioned on either side of the glass body and are brought into contact with the glass body at a temperature, at which the glass body is deformable, whereby the moulds are configured with electrically conductive surfaces.

An invention of this type is described in European Patent 0 978 492 A1. The intention of the known method is to eliminate hot bonding problems by bringing an insulating, non-metallic and an organic material that is to be deformed and that is in an electrical field in contact with a female die part at an appropriate temperature that is required for the forming process. The female die part and the insulator to be formed are kept in a polarized state during contact, whereby the surface of the female die part that comes in contact with the material is positively charged, and the surface of the insulator that is in contact with the female die part is negatively charged. In the practice of glass manufacture it has been demonstrated, however, that, by applying a direct current to the side with the continuously positive potential at higher temperatures, increased oxidation of the female die part material occurs. After a certain amount of processing time, this causes spalling of the oxide layer, which limits the useful life of the female die part material and causes defects in the glass. O₂ from the glass can form on the glass surface, which can result in the formation of bubbles, depending on the type of glass, exposure time, and temperature.

On the negative potential side, increased accumulation of alkali and alkaline earth ions occurs on the glass surface, which results in increased adhesion and increased evaporation of volatile components out of the glass. The reduction of polyvalent elements on the surface can result in discolorations there.

U.S. Pat. No. 4,684,388 and U.S. Pat. No. 4,828,596 describe the use of anti-stick components such as zinc and stannous oxide or copper sulfate. The success of these compositions greatly depends on the forming conditions, however. Moreover, mineral additives often result in discolorations, which are undesirable when it comes to producing glass, in particular.

Furthermore, lubricants are also used, but they evaporate at the high process temperatures and then precipitate in the near vicinity. As a result, high expenditures are required to suction it away, or production stations will become heavily contaminated with the lubricants, which also poses a greater fire hazard.

The object of the present invention, therefore, is to further develop the method, mentioned initially, for minimizing the adhesion tendency during the hot forming of a glass body in such a manner that the adhesion tendency is reduced and the surface quality of the glass body to be formed is increased.

A further secondary object is to provide a device for carrying out the method for minimizing the adhesion tendency.

The object is attained, according to the invention, using a method with which the conductive surfaces of the moulds that come in contact with the glass body are supplied with an alternating current. The advantage of alternating current over direct current lies mainly in the fact that the negatively polarized alternating current on both conductive surfaces brings about a negative polarization of the glass surface. When an alternating current is applied, given a conductive surface, O²⁺ ions accumulate and positive-charged alkali and/or alkaline earth ions are depleted on the glass surface during the positive impulse. During the negative impulse, O²⁺ ions are depleted, and positively-charged alkali and alkaline earth ions accumulate on the glass surface. Compared to the positively charged alkali and alkaline earth ions on the glass surface, the O²⁺ ions have a much higher chemical affinity for the conductive surface. As a result, the depletion of O²⁺ ions is less pronounced during the negative impulse than the depletion of positively charged alkali or alkaline earth ions on the glass surface. Both glass surfaces therefore become negatively charged when an alternating current is applied. Although this negative charging of the glass surface that occurs when an alternating current is applied to the conductive surfaces is weaker than on the positively polarized surface when a direct voltage is applied, it is sufficient to reduce the number of product defects and extend the useful life of the moulds. The use of lubricants can be reduced or even avoided, and the coating of the conductive surfaces can be eliminated, in some circumstances. The reduced adhesion tendency ensures that a larger processing window is available, i.e., a greater flexibility in, for example, the temperature, the forming pressure and the duration of contact. The reduced formation of condensate on moulds is a further advantage, which results in a longer useful life of the moulds. The moulds are usually replaced as soon as they are covered so heavily with deposits of volatile glass components that significant process impairments occur, or the product surfaces become damaged.

In a preferred exemplary embodiment, the conductive surfaces of the moulds are kept separated at a distance of from 0.6 mm to 30 mm. This corresponds to the thickness of the particular glass body to be processed, of between 0.6 mm and 30 mm.

Advantageously, mould surfaces are used that are made of a metal, a metal alloy, an electrically conductive ceramic or a conductive coating. The conductive surfaces of the moulds can be provided with a coating of chromium, for example. This helps to reduce the adhesion tendency.

In a favorable embodiment, the alternating current is generated with a frequency of 2000 to 20,000 Hz. This suppresses the occurrence of undesired oxidation-reduction reactions on the surfaces of the glass body particularly effectively. As the frequency of the alternating current increases, the current flow through the glass body decreases. At frequencies greater than 10,000 Hz, no further changes are visible, and current flow is zero.

In an advantageous exemplary embodiment, the alternating current is generated as square-wave voltage. An asymmetrical square-wave voltage is particularly favorable. Said asymmetrical square-wave voltage can have a longer maximum phase in the positive range than in the negative range.

The secondary object of the present invention, namely, to provide a device for carrying out the method, is attained, according to the invention, using a device with which the electrically conductive surfaces of the forming moulds are connected to an alternating current source.

Advantageously, at least one mould is equipped with means for adjusting the distance from the other forming mould. The ability to make adjustments allows the device to be adapted to different thicknesses of the glass body that are required.

In a particular exemplary embodiment, the surfaces of the forming moulds are made of a metal, a metal alloy, an electrically conductive ceramic, or a conductive coating. A mould surface of this type enables an electrically conductive connection between the mould and the glass body.

In a favorable embodiment, the conductive surfaces of the moulds have a coating of chromium. The chromium coating reduces the risk that the glass will adhere to the surface of the moulds.

As an alternative to coating the electrically conductive mould surfaces with a metal alloy, the mould surfaces can also be formed, preferably, using various coatings having different electrical conductivities, which said coatings are applied in sections. With this, an appropriate current can be impressed specifically in previously-defined segments of the glass body, depending on the particular coating that is contacted.

A square-wave voltage generator is advantageously used to generate the alternating current. Said square-wave voltage generator allows a defined square-wave voltage to be preset, preferably with a frequency of between 2000 and 20,000 Hz.

In a particular exemplary embodiment, the square-wave voltage generator generates an asymmetrical square-wave voltage. The negative voltage portion is reduced further as a result, which further reduces the negative effects—that are known in the related art—on the electrodes to which negative current is applied.

The invention will be described in greater detail hereinbelow with reference to the drawing as an example.

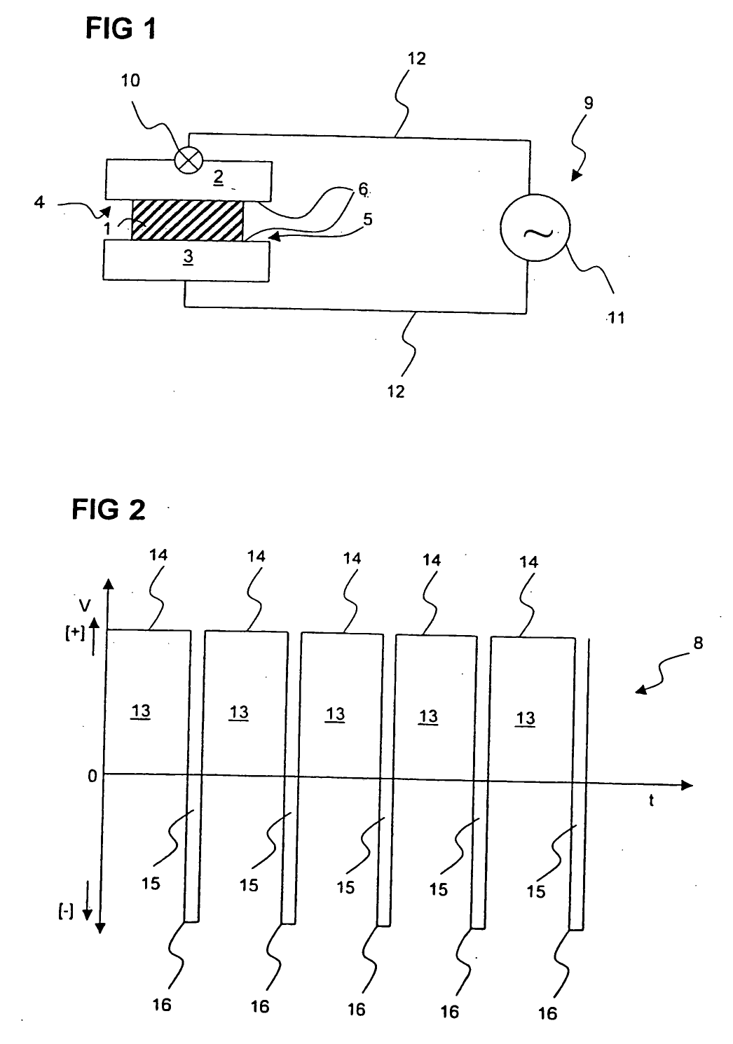

FIG. 1 is a schematic representation of a glass body to be deformed that is located between two moulds, and

FIG. 2 is a diagram of an asymmetrical square-wave voltage.

FIG. 1 is a schematic representation of the arrangement of a first mould 2 and a second mould 3 above and below a glass body 1. The first mould 2 has a first conductive surface 4, and the second mould 3 has a second conductive surface 5, each of them on the side facing the glass body 1. The conductive surfaces 4, 5 are each hardened and tempered a chromium coating 6 to reduce the adhesion tendency. In FIG. 1, means 10 are provided on the first mould 2 to adjust the distance from the second, non-adjustable mould 3. Using the means 10 for adjusting distance, the moulds 2, 3 can be adjusted for different thicknesses of the glass body 1. Both moulds 2, 3 are connected to an alternating current source 9 via cables 12. In the configuration in FIG. 1, the alternating current source 9 includes a square-wave voltage generator 11.

FIG. 2 shows, in diagram form, the course of voltage V of the asymmetrical square-wave voltage 8 over time t. In the positive phase portion 13, the voltage is maintained for the period of time 14, while, in the negative phase portion 15, it is maintained for the much shorter period of time 16. Due to the comparably short exposure time of the negative phase portion 15 on the glass body 1, the known effects caused by the negative voltage are reduced.

### Reference Numerals

1 Glass body

2 First mould

3 Second mould

4 First conductive surface

5 Second conductive surface

6 Chromium coating

8 Asymmetrical square-wave voltage

9 Alternating current source

10 Means for adjusting distance

11 Square-wave voltage generator

12 Cable

13 Positive phase portion

14 Time-positive voltage

15 Negative phase portion

16 Time-negative voltage

V Voltage

t Time

What is claimed is:

1. A method for reducing the adhesion tendency during the hot forming of a glass body (1), using at least two moulds (2, 3), which are positioned on either side of the glass body and are brought into contact with the glass body (1) at a temperature, at which the glass body (1) is deformable, whereby the moulds (2, 3) are configured with electrically conductive surfaces (4, 5),
wherein the conductive surfaces (4, 5) of the moulds (2, 3) that come in contact with the glass body are supplied with an alternating current.

2. The method as recited in claim 1,
wherein the electrically conductive surfaces (4, 5) of the moulds (2, 3) are separated by a distance of 0.6 mm to 30 mm.

3. The method as recited in one of the claims 1 or 2,
wherein electrically conductive mould surfaces (4, 5) that are made of a metal, a metal alloy, an electrically conductive ceramic or a conductive coating are used.

4. The method as recited in one of the claims 1 through 3,
wherein the alternating current is produced with a frequency of 2000 to 20,000 Hz.

5. The method as recited in one of the claims 1 through 4,
wherein the alternating current is produced as square-wave voltage.

6. The method as recited in claim 5,
wherein the square-wave voltage is produced as asymmetrical square-wave voltage (8).

7. A device for carrying out the method for reducing the adhesion tendency during the hot forming of a glass body (1) according to one of the claims 1 through 6, using at least two moulds (2, 3), which are positioned on either side of the glass body (1) and are brought into contact with the glass body (1) at a temperature, at which the glass body (1) is deformable, whereby the moulds (2, 3) are configured with an electrically conductive surface (4, 5),
wherein the electrically conductive surfaces (4, 5) are connected to an alternating current source (9).

8. The device as recited in claim 7,
wherein the moulds (2, 3) are equipped with at least one means (10) for adjusting the distance between it and the other mould.

9. The device as recited in claim 7 or 8,
wherein the electrically conductive mould surfaces (4, 5) are made of a metal or a metal alloy.

10. The device as recited in claim 9,
wherein the conductive surfaces (4, 5) of the moulds (2, 3) have a chromium coating (6).

11. The device as recited in claim 7 or 8,
wherein the electrically conductive mould surfaces (4, 5) are configured with various coatings having different electrical conductivities, which said coatings are applied in sections.

12. The device as recited in claims 7 through 11,
wherein a square-wave voltage generator (11) is used to generate the alternating current.

13. The device as recited in claim 12,
wherein the square-wave voltage generator (11) is designed to generate a frequency of between 2000 and 20,000 Hz.

14. The device as recited in claim 12 or 13,
wherein the square-wave voltage generator (11) is designed to generate an asymmetrical square-wave voltage (8).
